(19) United States
(12) Patent Application Publication
(10) Pub. No.: US 2010/0028780 A1
(43) Pub. Date: Feb. 4, 2010

(54) BATTERY ELECTRODE AND METHOD FOR MANUFACTURING THE SAME, AND BATTERY

(75) Inventors: Toshimitsu HIRAI, Hokuto (JP); Yasushi TAKANO, Matsumoto (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/533,229

(22) Filed: Jul. 31, 2009

(30) Foreign Application Priority Data
Aug. 4, 2008 (JP) 2008-200464

(51) Int. Cl. H01M 4/64; H01M 4/82

(52) U.S. Cl. 429/233; 29/623.5

(57) ABSTRACT

A battery electrode includes a current collector and an active material layer formed on a surface of the current collector. The active material layer includes an active material and a conductive material including a metal material.

### BACKGROUND

1. Technical Field

The present invention relates to a battery electrode and a method for manufacturing the same, and a battery.

2. Related Art

In recent years, in order to approach to environmental issues and the like, for example, in automotive industry, the development of batteries for driving a motor has been progressed. As the batteries for driving a motor, lithium ion secondary batteries have been developed from a perspective of high-power, long life, downsizing, and the like. An electrode of the lithium ion secondary battery includes, for example, a current collector and an active material layer that is formed on a surface of the current collector and includes an active material, and the like (e.g., refer to an example of related art, JP-A-2006-210003).

However, one of the problems in the battery having the structure described above is having high internal resistance.

### SUMMARY

The invention is proposed in order to solve the above-mentioned problem and can be achieved as the following aspects.

According to a first aspect of the invention, a battery electrode includes a current collector and an active material layer formed on a surface of the current collector. The active material layer includes an active material and a conductive material including a metal material.

According to the structure, including the metal material enables good electron conductivity to be ensured. Thus, internal resistance can be reduced.

In the battery electrode, the metal material may be a material for the current collector.

According to the structure, the material for the metal material and the current collector is the same, so that conductivity between the current collector and the active material layer can be further improved.

In the battery electrode, the metal material may be metal microparticles and a concentration of the metal microparticles in the active material layer increases toward the current collector from a surface of the active material layer.

According to the structure, electron conductivity in an interface region between the active material layer and the current collector can be increased.

In the battery electrode, the active material layer may include a conductive section having a protruded shape formed on the surface of the current collector and is made of the metal material.

According to the structure, the conductive section is internally formed in the active material layer, so that a conductive path of an electron is formed in a thickness direction of the active material layer. Thus, internal resistance can be reduced.

According to a second aspect of the invention, a battery includes a positive electrode, an electrolyte layer, and a negative electrode. In the battery, at least one of the positive electrode and the negative electrode includes the battery electrode according to the first aspect.

According to the structure, a battery having reduced internal resistance can be provided. The battery in this case may be employed as a structure of a lithium ion secondary battery. Then, other than vehicles, power tools, and the like requiring high power, the battery can be included in electronic apparatuses and the like.

According to a third aspect of the invention, a method for manufacturing a battery electrode including a current collector and an active material layer including forming the active material layer on a surface of the current collector by applying a liquid body serving as a material for the active material layer. In the method, the liquid body in forming the active material layer includes an active material and a conductive material including a metal material promoting electron conductivity between the current collector and the active material.

According to the structure, including the metal material enables good electron conductivity to be ensured. Thus, internal resistance can be reduced.

In the method for manufacturing the battery electrode, the metal material in forming the active material layer may be a material for the current collector.

According to the structure, the material for the metal material and the current collector is the same, so that electron conductivity can further be increased.

In the method for manufacturing the battery electrode, the liquid body may include a plurality of liquid bodies and the metal material included in the liquid body may be metal microparticles in forming the active material layer. The liquid bodies having a different concentration of the metal microparticles may be applied so that the concentration of the metal microparticles in the active material layer increases toward the current collector from a surface of the active material layer.

According to the structure, electron conductivity in an interface region between the active material layer and the current collector can be increased.

In the method for manufacturing the battery electrode, forming the active material layer may include forming a conductive section having a protruded shape by applying the liquid body including the metal material on the surface of the current collector.

According to the structure, the conductive section is internally formed in the active material layer, so that a conductive path of an electron is formed in a thickness direction of the active material layer. Thus, internal resistance can be reduced.

### BRIEF DESCRIPTION OF THE DRAWINGS

The invention will be described with reference to the accompanying drawings, wherein like numbers reference like elements.

FIG. 1 is a sectional view schematically showing a structure of a battery.

FIG. 2 is a sectional view schematically showing a structure of a battery electrode according to a first embodiment.

FIG. 3 is a perspective view schematically showing a structure of a droplet ejecting device.

FIGS. 4A and 4B show a structure of an ejecting head. FIG. 4A is a perspective view with a part thereof broken down. FIG. 4B is a sectional view thereof.

FIG. 5 is a block diagram showing a structure of a controller of the droplet ejecting device.

FIGS. 6A to 6E are schematic views showing a method for manufacturing a battery electrode according to the first embodiment.

FIG. 7 is a sectional view schematically showing a structure of the battery electrode according to a second embodiment.

FIGS. 8A to 8E are schematic views showing a method for manufacturing a battery electrode according to the second embodiment.

### DESCRIPTION OF EXEMPLARY EMBODIMENTS

Embodiments of the invention will now be described with reference to the accompanying drawings. The scales of members in the drawings are adequately changed so that they can be recognized.

### First Embodiment

Structure of Battery

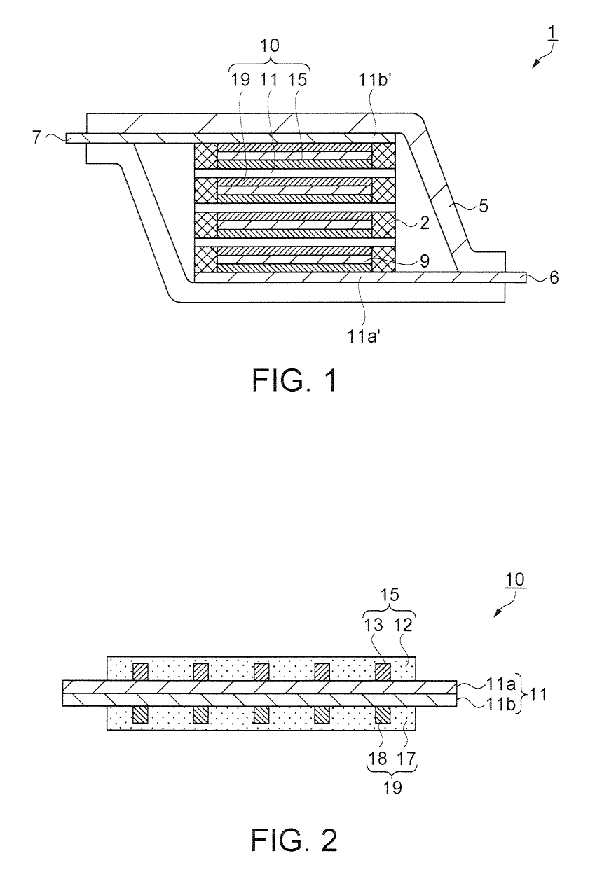

First, a structure of a battery according to the invention will be described. FIG. 1 is a sectional view schematically showing the structure of the battery. In the embodiment, a bipolar-type lithium ion secondary battery (hereinafter also referred to as a “bipolar battery”) will be described as an example.

A bipolar battery 1 includes battery electrodes 10 that are laminated, electrolyte layers 9 disposed between the laminated battery electrodes 10, and a sheet member 5 wrapping the battery electrodes 10 and the electrolyte layers 9. To be more specific, the battery electrode 10 includes a positive electrode active material layer 15 and a negative electrode active material layer 19 formed on each surface of a current collector 11 (the battery electrode will be described in detail later). The electrode battery 10 is laminated such that the positive electrode active material layer 15 in one of the battery electrodes 10 and the negative electrode active material layer 19 in adjacent battery electrode 10 are opposed to each other with the electrolyte layer 9 interposed therebetween. The number of laminates of the battery electrode 10 is not particularly limited.

A periphery of the battery electrode 10 includes an insulation layer 2 insulating between adjacent current collectors 11. The positive electrode active material layer 15 or the negative electrode active material layer 19 is formed on only one side of each of the outermost layer current collectors 11a′ and 11b′ positioned at the outermost layer in the laminated battery electrodes 10. Then, the outermost layer current collectors 11a′ provided on a positive electrode side is extended from the sheet member 5 as a positive electrode 6. On the other hand, the outermost layer current collectors 11b′ provided on a negative electrode side is extended from the sheet member 5 as a negative electrode 7.

As an electrolyte of the electrolyte layer 9, a liquid electrolyte or a polymer electrolyte can be used.

The liquid electrolyte has a configuration that lithium salt serving as supporting salt is dissolved in an organic solvent. Examples of the organic solvent include carbonates such as ethylene carbonate (EC) and propylene carbonate (PC). As the supporting salt (the lithium salt), a compound, such as LiBETI, can be employed that can be added to the active material layer.

On the other hand, the polymer electrolyte is classified into a gel electrolyte that includes an electrolytic solution and an intrinsic polymer electrolyte that does not include an electrolytic solution.

The gel electrolyte has a structure that the liquid electrolyte is injected into a matrix polymer made of an ion-conductive polymer. Examples of the ion-conductive polymer used as the matrix polymer include polyethylene oxide (PEO), polypropylene oxide (PPO), a copolymer thereof, and the like.

In a case where the electrolyte layer 9 is made of the liquid electrolyte or the gel electrolyte, a separator may be used for the electrolyte layer 9. As the separator, a microporous film made of polyolefin, such as polyethylene and polypropylene, can be used.

The intrinsic polymer electrolyte has a structure that the supporting salt (the lithium salt) is dissolved in the matrix polymer, and does not include an organic solvent. Thus, in a case where the electrolyte layer 9 is made of the intrinsic polymer electrolyte, liquid leakage can be prevented.

As the insulation layer 2, a material can be employed that has insulation properties, sealing properties for preventing removal of the active material and permeation of moisture, and heat resistance properties, and the like. Examples of the material include urethane resin, epoxy resin, polyethylene resin, polypropylene resin, polyimide resin, rubber, and the like.

As the positive electrode 6 and the negative electrode 7, aluminum, copper, titanium, nickel, stainless steel, and the like can be used.

As the sheet member 5, a laminate sheet of polymer and metal can be used.

Structure of Battery Electrode

Next, a structure of the battery electrode will be described. FIG. 2 is a sectional view schematically showing the structure of the battery electrode according to the embodiment. In the embodiment, a bipolar electrode will be described as an example.

The battery electrode 10 includes the positive electrode active material layer 15 formed on a surface of a positive electrode current collector 11a and the negative electrode active material layer 19 formed on a surface of a negative electrode current collector 11b. The positive electrode active material layer 15 includes a positive electrode active material section 12 and a first conductive section 13 having a protruded shape. The positive electrode active material section 12 includes a positive electrode active material and a first conductive material. The first conductive section 13 is formed on the surface of the positive electrode current collector 11a, and is made of a metal material serving as a second conductive material. Meanwhile, the negative electrode active material layer 19 includes a negative electrode active material section 17 and a second conductive section 18 having a protruded shape. The negative electrode active material section 17 includes a negative electrode active material and the first conductive material. The second conductive section 18 is formed on the surface of the negative electrode current collector 11b, and is made of a metal material serving as a third conductive material.

As each of the current collectors 11a and 11b, a conductive material, such as aluminum foil, nickel foil, copper foil, and stainless steel foil, can be employed. In the embodiment, aluminum foil is employed as a material for the positive electrode current collector 11a, and copper foil is employed as a material for the negative electrode current collector 11b.

Examples of the positive electrode active material of the positive electrode active material section 12 include lithium cobaltate (LiCoO₂), lithium nickelate (LiNiO₂), lithium manganate (LiMn₂O₄), lithium iron phosphate (LiFePO₄), lithium nickel cobalt oxide (LiNi₁₋ₓCoₓO₂), lithium nickel manganese dioxide (LiNi_{0.5}Mn_{0.5}O₂), lithium nickel manganese cobalt oxide (LiNi_{1/3}Mn_{1/3}Co_{1/3}O₂), lithium titanate (Li₄Ti₅O₁₂), lithium sulfide (Li₂S), and the like. Further, two or more materials above may be combined.

Examples of the first conductive material of the positive electrode active material section 12 include a carbon powder, such as acetylene black and graphite, and various carbon fibers, such as vapor grown carbon fiber (VGCF (trademark registered)).

As the first conductive section 13, for example, aluminum, the same material for the positive electrode current collector 11a, can be employed as well as a metal material, such as nickel, gold, silver, and copper.

Examples of the negative electrode active material of the negative electrode active material section 17 include a compound of carbon with lithium/lithiated graphite (LiC₆), lithium titanate (Li₄Ti₅O₁₂), a compound of silicon with lithium (Li₂₂Si₅), lithium (Li), and the like. Further, two or more materials above may be combined.

As the first conductive material of the negative electrode active material section 17, the material for the first conductive material of the positive electrode active material section 12 mentioned above can be used.

As the second conductive section 18, for example, copper, the same material for the negative electrode current collector 11b, can be employed as well as a metal material, such as nickel, gold, and silver.

Structure of Droplet Ejecting Device

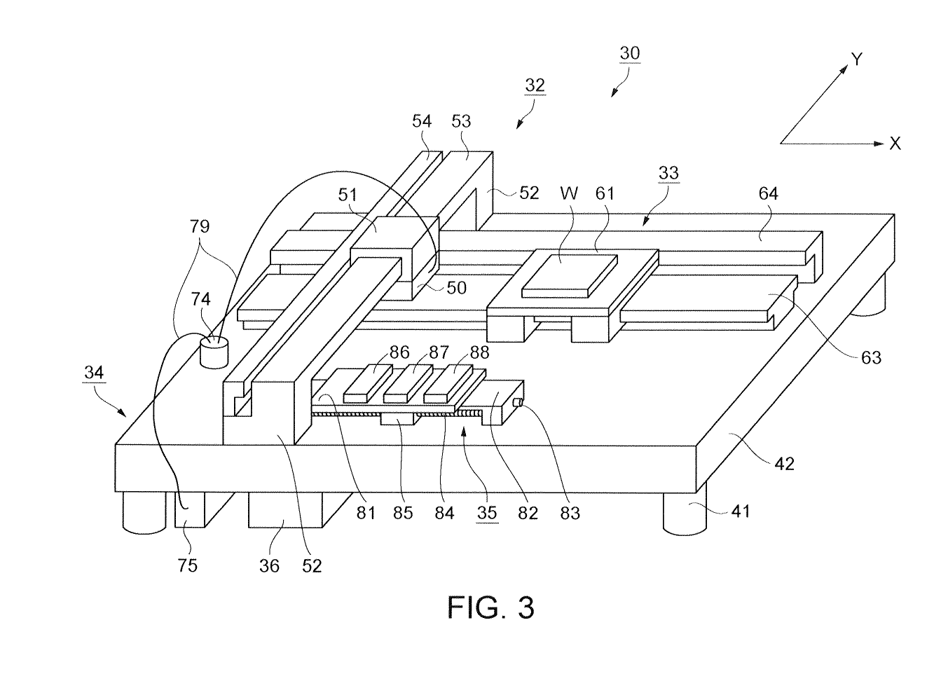

Next, a structure of a droplet ejecting device used for manufacturing the battery electrode 10 will be described. In the embodiment, a droplet ejecting method will be described as an example of applying a liquid body serving as a material for the active material layer of the battery electrode 10. FIG. 3 is a perspective view schematically showing a structure of the droplet ejecting device enabling the droplet ejecting method.

Referring to FIG. 3, a droplet ejecting device 30 includes a head mechanism section 32 including a head section 50 ejecting the liquid body serving as a material for the active material layer as droplets, a work mechanism section 33 placing a workpiece W to which the droplets from the head section 50 are ejected, a material supply section 34 supplying the head section 50 with the liquid body, a maintenance mechanism section 35 performing maintenance of the head section 50, a controller 36 generally controlling each mechanism section and the supply section, and the like.

The droplet ejecting device 30 includes a plurality of support legs 41 set on the floor and a platen 42 set on the support legs 41. Disposed on the platen 42 is the work mechanism section 33 so as to extend in a longitudinal direction of the platen 42 (in an X-axis direction). Disposed above the work mechanism section 33 is the head mechanism section 32 supported by two support posts 52 fixed to the platen 42 so as to extend in a direction orthogonal to the work mechanism section 33 (in a Y-axis direction). Disposed at one end of the platen 42 is the material supply section 34 communicating with the head section 50 of the head mechanism section 32 so as to supply the liquid body. Disposed at the vicinity of one support post 52 of the head mechanism section 32 is the maintenance mechanism section 35 so as to extend in the X-axis direction and be adjacent to the work mechanism section 33. The controller 36 is disposed under the platen 42.

The head mechanism section 32 includes the head section 50 ejecting the liquid body, a head carriage 51 suspending the head section 50, a Y-axis guide 53 guiding a movement of the head carriage 51 in the Y-axis direction, a Y-axis linear motor 54 disposed at a side of the Y-axis guide 53 so as to be parallel to each other, and the like.

The work mechanism section 33 is disposed lower than the head mechanism section 32 so as to extend in the X-axis direction almost in the same manner as the head mechanism section 32. The work mechanism section 33 includes a table 61 placing the workpiece W thereon, an X-axis guide 63 guiding a movement of the table 61, an X-axis linear motor 64 disposed at a side of the X-axis guide 63 so as to be parallel to each other, and the like. With these structures, it is possible to freely move the head section 50 and the workpiece W reciprocally in the Y-axis direction and the X-axis direction, respectively.

The material supply section 34 supplying the head section 50 with the liquid body includes a tank 75, a pump 74, and a flow passage tube 79 coupling the tank 75 to the head section 50 through the pump 74.

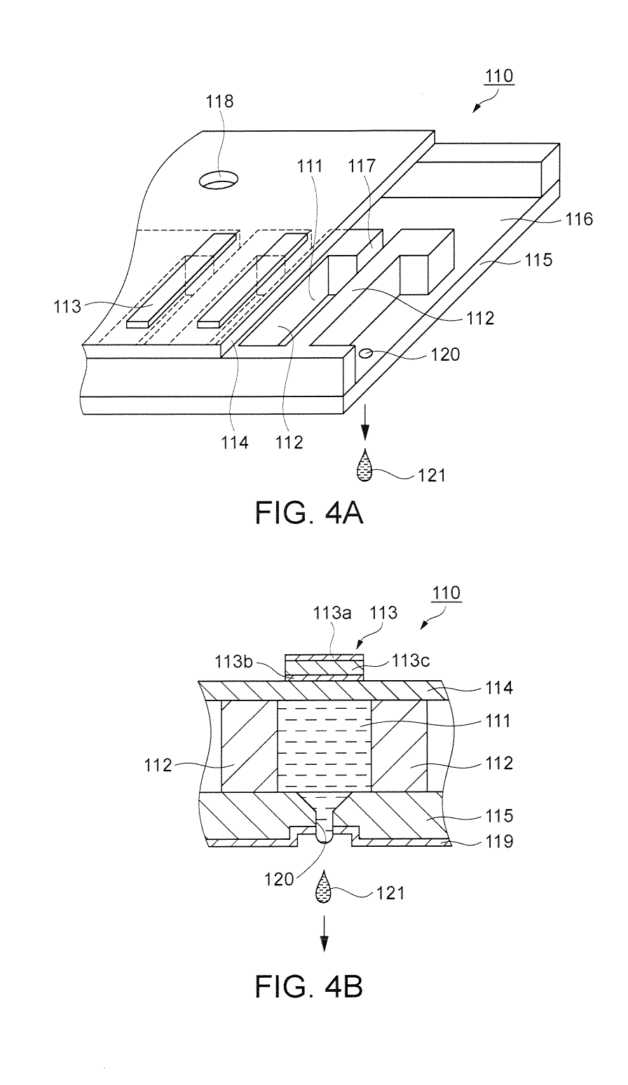

Next, a structure of an ejecting head included in the head section 50 will be described. FIGS. 4A and 4B show the structure of the ejecting head. FIG. 4A is a perspective view with a part thereof broken down while FIG. 4B is a sectional view thereof.

Referring to FIG. 4A, an ejecting head 110 includes a vibrating plate 114 and a nozzle plate 115. Provided between the vibrating plate 114 and the nozzle plate 115 is a reservoir 116 always filled with the liquid body supplied through a hole 118. Provided between the vibrating plate 114 and the nozzle plate 115 is a plurality of partitions 112. An area surrounded by the vibrating plate 114, the nozzle plate 115, and a pair of partitions 112 is a cavity 111. Since the cavity 111 is provided correspondingly to a nozzle 120, the cavity 111 is provided in the same number as the nozzle 120. The liquid body is supplied from the reservoir 116 to the cavity 111 through a supply port 117 placed between the pair of partitions 112.

Referring to FIG. 4B, an oscillator 113 corresponding to the cavity 111 is mounted on the vibrating plate 114. The oscillator 113 includes a piezo element 113c and a pair of electrodes 113a and 113b sandwiching the piezo element 113c. By giving a driving voltage to the pair of electrodes 113a and 113b, the liquid body is ejected as droplets 121 from the corresponding nozzle 120. Here, an electrothermal converting element may be used instead of the oscillator 113 to eject the liquid body. In this case, thermal expansion of the liquid body driven by the element is used to eject the liquid material as droplets.

Referring back to FIG. 3, the maintenance mechanism section 35 will be described. The maintenance mechanism section 35 includes a maintenance unit for a capping unit 86, a wiping unit 87, and a flushing unit 88. The maintenance mechanism section 35 further includes a maintenance carriage 81 placing the maintenance unit thereon, a maintenance carriage guide 82 guiding a movement of the maintenance carriage 81, a threaded section 85 integrated with the maintenance carriage 81, a ball screw 84 screwed together with the threaded section 85, and a maintenance motor 83 rotating the ball screw 84. Accordingly, if the maintenance motor 83 rotates forwardly or reversely, the ball screw 84 rotates, so that the maintenance carriage 81 moves in the X-axis direction with the threaded section 85. In a case where the maintenance carriage 81 moves for the maintenance of the head section 50, the head section 50 moves along the Y-axis guide 53 so as to face directly above the maintenance unit. With these maintenance units, a state of the ejecting head 110 is maintained so as to keep a good ejecting state during non-operation time of the droplet ejecting device 30, processing waiting time in which the workpiece W is exchanged and placed, and the like.

With these structures, it is possible to freely move the head section 50 and the workpiece W reciprocally in the Y-axis direction and the X-axis direction, respectively.

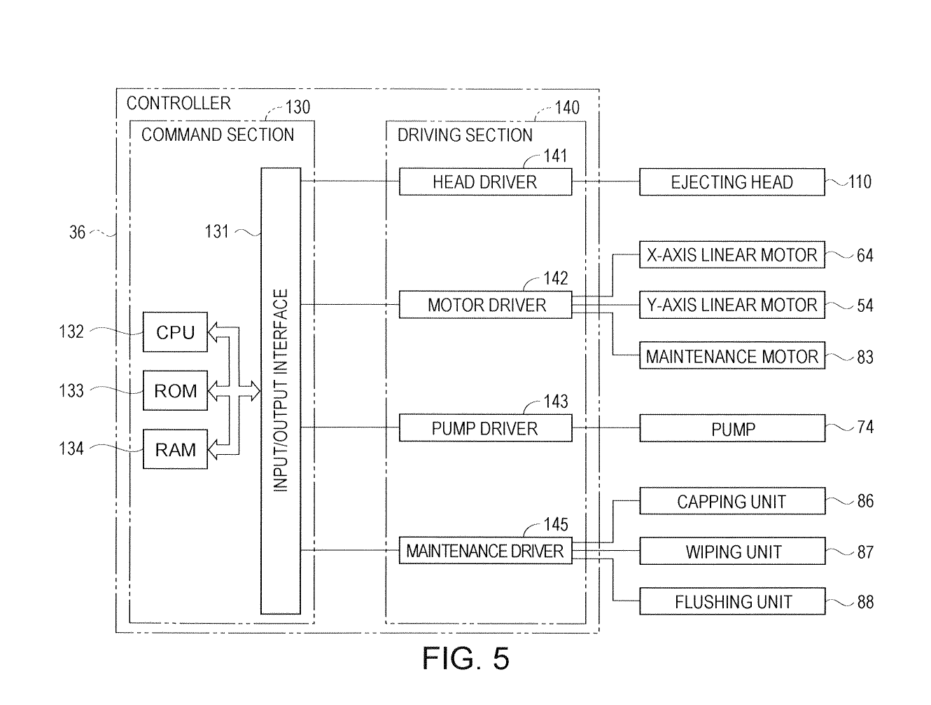

Next, a structure of the controller 36 controlling the structures described above will be described. FIG. 5 is a block diagram showing the structure of the controller 36. The controller 36 includes a command section 130 and a driving section 140. The command section 130 includes a CPU 132, a ROM 133 and a RAM 134 serving as a storing device, and an input/output interface 131. The CPU 132 processes various signals inputted through the input/output interface 131 based on data in the ROM 133 and the RAM 134 so as to output control signals to the driving section 140 through the input/output interface 131.

The driving section 140 includes a head driver 141, a motor driver 142, a pump driver 143, and a maintenance driver 145. The motor driver 142 controls the X-axis linear motor 64 and the Y-axis linear motor 54 by the control signal of the command section 130 so as to control the movement of the workpiece W and the head section 50. Further, the motor driver 142 controls the maintenance motor 83 so as to move the units required for the maintenance mechanism section 35 to a maintenance position. The head driver 141 controls the ejection of the liquid body from the ejecting head 110 and, in synchronization with the control of the motor driver 142, allows an ejecting operation and the like to be performed on a predetermined position of the workpiece W. The pump driver 143 controls the pump 74 corresponding to an ejecting state of the liquid body so as to optimally control the supply to the ejecting head 110. The maintenance driver 145 controls the capping unit 86, the wiping unit 87, and the flushing unit 88 of the maintenance mechanism section 35.

Method for Manufacturing Battery Electrode

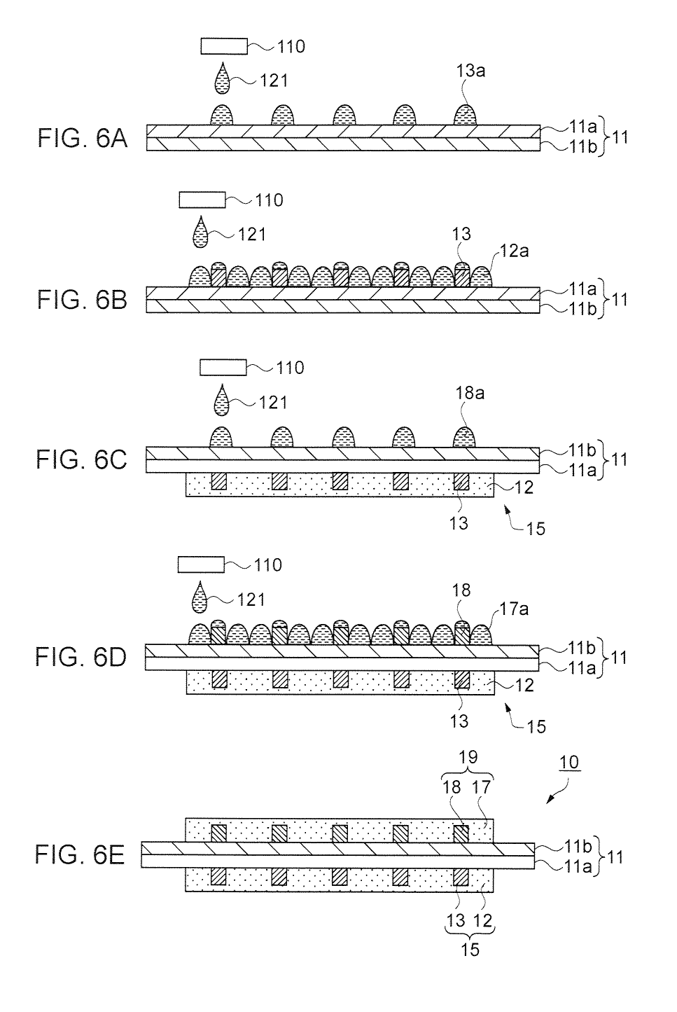

Next, a method for manufacturing a battery electrode will be described. FIGS. 6A to 6E are schematic views showing the method for manufacturing a battery electrode according to the first embodiment.

First, a step of forming the positive electrode active material layer will be described. In a step of forming a first conductive section shown in FIG. 6A, a first liquid body serving as a material for the first conductive section 13 is applied on the surface of the positive electrode current collector 11a. To be specific, the first liquid body is ejected as the droplets 121 from the ejecting head 110 of the droplet ejecting device 30 to a predetermined region on the surface of the positive electrode current collector 11a so as to apply a first liquid body 13a on the positive electrode current collector 11a. In the embodiment, the first liquid body 13a is applied so as to be dotted on the surface of the positive electrode current collector 11a. As the first liquid body 13a, for example, a liquid body is used that includes a solvent and aluminum microparticles that are a metal material. Then, the first liquid body 13a applied is solidified by drying treatment and the like so as to form the first conductive section 13 having a protruded shape.

Referring to FIG. 6B, a second liquid body serving as a material for the positive electrode active material section 12 is applied on the surface of the positive electrode current collector 11a and the first conductive section 13. To be specific, the second liquid body is ejected as the droplets 121 from the ejecting head 110 of the droplet ejecting device 30 to the surface of the positive electrode current collector 11a and the first conductive section 13 so as to apply a second liquid body 12a on the positive electrode current collector 11a and the first conductive section 13. As the second liquid body 12a, for example, a liquid body is used that includes a solvent, the lithium manganate (LiMn₂O₄) serving as the positive electrode active material, and the acetylene black serving as the first conductive material. Then, the second liquid body 12a applied is solidified by drying treatment and the like so as to form the positive electrode active material section 12.

By going through the steps above, the positive electrode active material layer 15 is formed that includes the positive electrode active material section 12 and the first conductive section 13 (FIG. 6C).

Next, a step of forming the negative electrode active material layer will be described. In a step of forming the second conductive section shown in FIG. 6C, a third liquid body serving as a material for the second conductive section 18 is applied on the surface of the negative electrode current collector 11b. To be specific, the third liquid body is ejected as the droplets 121 from the ejecting head 110 of the droplet ejecting device 30 to the negative electrode current collector 11b so as to apply a third liquid body 18a on the negative electrode current collector 11b. In the embodiment, the third liquid body 18a is applied so as to be dotted on the surface of the negative electrode current collector 11b. As the third liquid body 18a, for example, a liquid body is used that includes a solvent and copper microparticles that are a metal material. Then, the third liquid body 18a applied is solidified by drying treatment and the like so as to form the second conductive section 18 having a protruded shape.

Referring to FIG. 6D, a fourth liquid body serving as a material for the negative electrode active material section 17 is applied on the surface of the negative electrode current collector 11b and the second conductive section 18. To be specific, the fourth liquid body is ejected as the droplets 121 from the ejecting head 110 of the droplet ejecting device 30 to the surface of the negative electrode current collector 11b and the second conductive section 18 so as to apply a fourth liquid body 17a on the negative electrode current collector 11b and the second conductive section 18. As the fourth liquid body 17a, for example, a liquid body is used that includes lithium manganate (Li₄Ti₅O₁₂) serving as the negative electrode active material and acetylene black serving as the first conductive material in a solvent. Then, the fourth liquid body 17a applied is solidified by drying treatment and the like so as to form the negative electrode active material section 17.

By going through the steps above, the negative electrode active material layer 19 is formed that includes the negative electrode active material section 17 and the second conductive section 18. Then, the battery electrode 10 (the bipolar electrode) as a whole is formed (FIG. 6E).

The first embodiment provides the following effects.

By respectively forming the first and the second conductive sections 13 and 18 on the surface of the current collectors 11a and 11b, a conductive path is formed in each of the active material layers 15 and 19. Accordingly, electron conductivity is improved, and internal resistance can be reduced.

The material for the first and the second conductive sections 13 and 18 is respectively the same as that for the current collectors 11a and 11b corresponding to the conductive sections, so that electron conductivity can be further improved.

The first and the second conductive sections 13 and 18 are formed in a protruded shape, so that electron conductivity is efficiently ensured with respect to a thickness direction of each of the active material layers 15 and 19.

By respectively forming the first and the second conductive sections 13 and 18 on the surface of the current collectors 11a and 11b, the surface of the current collectors 11a and 11b has a protruded and recessed shape. Therefore, respective contact areas with the active material sections 12 and 17 increase. Thus, contact resistance between the current collectors 11a and 11b and the active material layers 15 and 18 can be reduced, respectively.

### Second Embodiment

Next, a second embodiment according to the invention will be described. Since the basic structures of the battery and the droplet ejecting device are the same of those in the first embodiment, the descriptions thereof will be omitted.

Structure of Battery Electrode

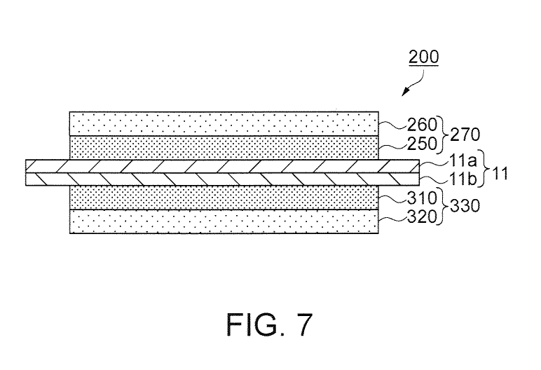

FIG. 7 is a sectional view schematically showing a structure of a battery electrode according to the embodiment. In the embodiment, a bipolar electrode will be described as an example.

A battery electrode 200 includes a positive electrode active material layer 270 formed on the surface of the positive electrode current collector 11a and a negative electrode active material layer 330 formed on the surface of the negative electrode current collector 11b. The positive electrode active material layer 270 includes a first positive electrode active material layer 250 formed on the surface of the positive electrode current collector 11a and a second positive electrode active material layer 260 formed on the first positive electrode active material layer 250. Meanwhile, the negative electrode active material layer 330 includes a first negative electrode active material layer 310 formed on the surface of the negative electrode current collector 11b and a second negative electrode active material layer 320 formed on the first negative electrode active material layer 310.

The positive electrode active material layer 270 includes the positive electrode active material, the first conductive material, and the second conductive material serving as a metal material while the negative electrode active material layer 330 includes the negative electrode active material, the first conductive material, and the metal material serving as a third conductive material. A concentration of the metal material included in the each of the active material layers 270 and 330 respectively increases to the current collectors 11a and 11b from the surface of the active material layers 270 and 330.

As each of the current collectors 11a and 11b, a conductive material, such as aluminum foil, nickel foil, copper foil, and stainless steel foil, can be employed. In the embodiment, the aluminum foil is employed as a material for the positive electrode current collector 11a, and the copper foil is employed as a material for the negative electrode current collector 11b.

Examples of the positive electrode active material included in the positive electrode active material layer 270 include lithium cobaltate (LiCoO₂), lithium nickelate (LiNiO₂), lithium manganate (LiMn₂O₄), lithium iron phosphate (LiFePO₄), lithium nickel cobalt dioxide (LiNi₁₋ₓCoₓO₂), lithium nickel manganese oxide (LiNi_{0.5}Mn_{0.5}O₂), lithium nickel manganese cobalt oxide (LiNi_{1/3}Mn_{1/3}Co_{1/3}O₂), lithium titanate (Li₄Ti₅O₁₂), lithium sulfide (Li₂S), and the like. Further, two or more materials above may be combined.

Examples of the first conductive material included in the positive electrode active material layer 270 include a carbon powder, such as acetylene black and graphite, and various carbon fibers, such as vapor grown carbon fiber (VGCF (trademark registered)).

As the metal material serving as the second conductive material included in the positive electrode active material layer 270, for example, aluminum, the same material for the positive electrode current collector 11a, is preferably employed. Besides, a metal material, such as nickel, gold, silver, and copper, may also be employed.

Examples of the negative electrode active material of the negative electrode active material layer 330 include a compound of carbon with lithium/lithiated graphite (LiC₆), lithium titanate (Li₄Ti₅O₂), a compound of silicon with lithium (Li₂₂Si₅), lithium (Li), and the like. Further, two or more materials above may be combined.

As the first conductive material of the negative electrode active material layer 330, the material for the first conductive material of the positive electrode active material layer 270 mentioned above can be used.

As the metal material serving as the third conductive material included in the negative electrode active material layer 330, for example, copper, the same material for the negative electrode current collector 11b, is preferably employed. Besides, a metal material, such as nickel, gold, and silver, can also be employed.

Method for Manufacturing Battery Electrode

Next, a method for manufacturing the battery electrode will be described.

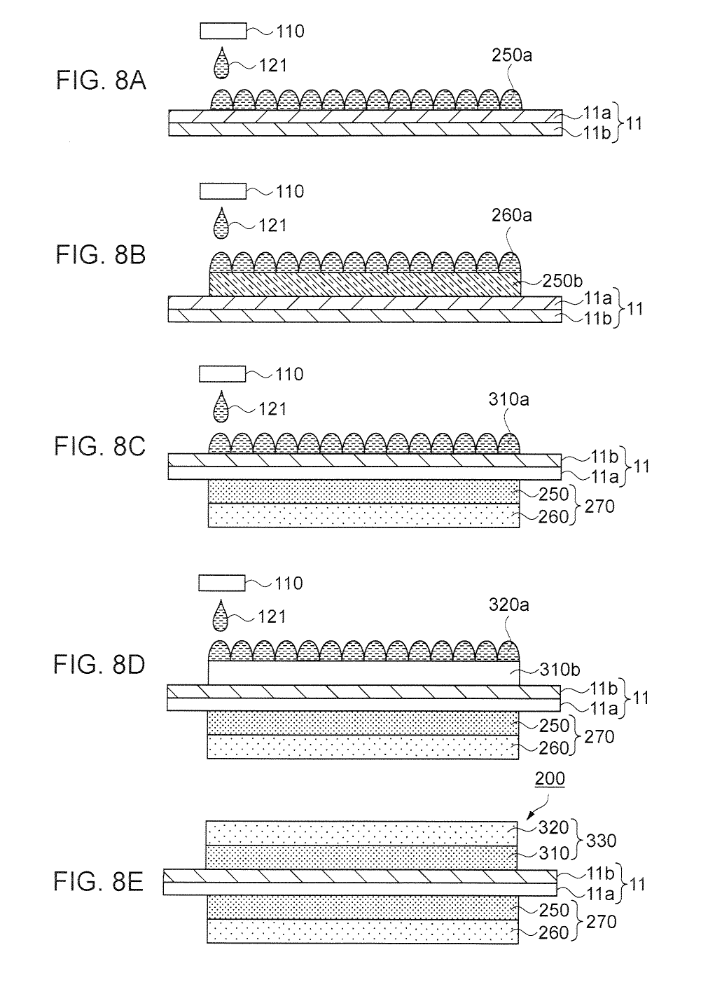

First, a step of forming the positive electrode active material layer will be described. Referring to FIG. 8A, a first liquid body serving as a material for the first positive electrode active material layer 250 is applied on the surface of the positive electrode current collector 11a. To be specific, the first liquid body is ejected as the droplets 121 from the ejecting head 110 of the droplet ejecting device 30 to the surface of the positive electrode current collector 11a so as to apply a first liquid body 250a on the positive electrode current collector 11a. As the first liquid body 250a, for example, a liquid body is used that includes a solvent, lithium manganate (LiMn₂O₄) serving as the positive electrode active material, acetylene black serving as the first conductive material, and aluminum microparticles that are a metal material serving as the second conductive material adjusted to a predetermined concentration. Then, the first liquid body 250a applied becomes viscous by air drying and the like, so that a first positive electrode active material layer 250b in a liquid state is formed.

Referring to FIG. 8B, a second liquid body serving as a material for the second positive electrode active material layer 260 is applied on the first positive electrode active material layer 250b in a liquid state. To be specific, the second liquid body is ejected as the droplets 121 from the ejecting head 110 of the droplet ejecting device 30 to the first positive electrode active material layer 250b in a liquid state so as to apply a second liquid body 260a thereto. As the second liquid body 260a, for example, a liquid body is used that includes a solvent, lithium manganate (LiMn₂O₄) serving as the positive electrode active material, acetylene black serving as the first conductive material, and aluminum microparticles that are a metal material serving as the second conductive material adjusted to a predetermined concentration.

Then, the first positive electrode active material layer 250b in a liquid state and the second liquid body 260a are solidified by drying treatment and the like so as to form the first positive electrode active material layer 250 and the second positive electrode active material layer 260. Accordingly, the positive electrode active material layer 270 is formed (FIG. 8C).

Here, a concentration of the aluminum microparticles included in the first liquid body 250a is adjusted to be higher than that of the aluminum microparticles included in the second liquid body 260a. Accordingly, the concentration of the aluminum microparticles included in the first positive electrode active material layer 250 is higher than that of the aluminum microparticles included in the second positive electrode active material layer 260, and thereby the positive electrode active material layer 270 having a concentration gradient is formed. In the concentration gradient, the concentration of the aluminum microparticles increases toward the surface of the positive electrode current collector 11a.

Next, a step of forming the negative electrode active material layer will be explained. Referring to FIG. 8C, a third liquid body serving as a material for the first negative electrode active material layer 310 is applied on the surface of the negative electrode current collector 11b. To be specific, the third liquid body is ejected as the droplets 121 from the ejecting head 110 of the droplet ejecting device 30 to the surface of the negative electrode current collector 11b so as to apply a third liquid body 310a on the negative electrode current collector 11b. As the third liquid body 310a, for example, a liquid body is used that includes a solvent, lithium titanate (Li₄Ti₅O₁₂) serving as the negative electrode active material, acetylene black serving as the first conductive material, and copper microparticles that are a metal material serving as the third conductive material adjusted to a predetermined concentration. Then, the third liquid body 310a applied becomes viscous by air drying and the like, so that a first negative electrode active material layer 310b in a liquid state is formed.

Referring to FIG. 8D, a fourth liquid body serving as a material for the second negative electrode active material layer 320 is applied on the first negative electrode active material layer 310b in a liquid state. To be specific, the fourth liquid body is ejected as the droplets 121 from the ejecting head 110 of the droplet ejecting device 30 to the first negative electrode active material layer 310b in a liquid state so as to apply a fourth liquid body 320a thereto. As the fourth liquid body 320a, for example, a liquid body is used that includes a solvent, lithium titanate (Li₄Ti₅O₁₂) serving as the negative electrode active material, acetylene black serving as the first conductive material, and copper microparticles that are a metal material serving as the third conductive material adjusted to a predetermined concentration.

Then, the first negative electrode active material layer 310b in a liquid state and the fourth liquid body 320a are solidified by drying treatment and the like so as to form the first negative electrode active material layer 310 and the second negative electrode active material layer 320. Accordingly, the negative electrode active material layer 330 is formed (FIG. 8E).

Here, a concentration of the copper microparticles included in the third liquid body 310a is adjusted to be higher than that of the copper microparticles included in the fourth liquid body 320a. Accordingly, the concentration of the copper microparticles included in the first negative electrode active material layer 310 is higher than that of the copper microparticles included in the second negative electrode active material layer 320, and thereby the negative electrode active material layer 330 having a concentration gradient is formed. In the concentration gradient, the concentration of the copper microparticles increases toward the surface of the negative electrode current collector 11b.

By going through the steps above, the battery electrode 200 (the bipolar electrode) is formed.

The second embodiment provides the following effects in addition to those of the first embodiment.

The concentration of the metal material increases toward each of the current collectors 11a and 11b, so that electron conductivity in the current collector can be promoted.

In forming the first positive electrode active material layer 250 and the second positive electrode active material layer 260, the second liquid body 260a, serving as a material for the second positive electrode active material layer 260, is applied on the first positive electrode active material layer 250b in a liquid state, and is solidified thereafter. Therefore, contact resistance between each of the active material layers can be reduced.

It is understood that the invention is not limited to the embodiments described above, and the following modifications can be made.

First Modification

In the first embodiment above, the metal material is included to the positive electrode active material layer 15 and the negative electrode active material layers 19 of the respective current collectors 11a and 11b. However it is not particularly limited to this. The metal material may be included to only either one of the active material layers. Also in this case, the same effect as in the embodiments described above can be obtained.

Second Modification

In the second embodiment, each of the active material layers 270 and 330 has a double-layer structure. However, it is not particularly limited to this structure. For example, the active material layer may have a single layer, or three layers or more. In this case, the active material layer may be formed such that a concentration of the metal material included in the active material layer increases toward the current collector from the surface of the active material layer. Also in this case, a concentration gradient of the metal material can be formed in the active material layer.

What is claimed is:

1. A battery electrode, comprising:
a current collector; and
an active material layer formed on a surface of the current collector, the active material layer including:
an active material; and
a conductive material including a metal material.

2. The battery electrode according to claim 1, wherein the metal material is a material for the current collector.

3. The battery electrode according to claim 1, wherein the metal material is metal microparticles and a concentration of the metal microparticles in the active material layer increases toward the current collector from a surface of the active material layer.

4. The battery electrode according to claim 1, wherein the active material layer includes a conductive section having a protruded shape formed on the surface of the current collector and is made of the metal material.

5. A battery, comprising:
a positive electrode;
an electrolyte layer; and
a negative electrode, wherein at least one of the positive electrode and the negative electrode includes the battery electrode according to claim 1.

6. A method for manufacturing a battery electrode including a current collector and an active material layer, comprising:
forming the active material layer on a surface of the current collector by applying a liquid body serving as a material for the active material layer, wherein the liquid body in forming the active material layer includes an active material and a conductive material including a metal material promoting electron conductivity between the current collector and the active material.

7. The method for manufacturing a battery electrode according to claim 6, wherein the metal material in forming the active material layer is a material for the current collector.

8. The method for manufacturing a battery electrode according to claim 6, wherein the liquid body includes a plurality of liquid bodies and the metal material included in the liquid body is metal microparticles in forming the active material layer, and the liquid bodies having a different concentration of the metal microparticles are applied so that the concentration of the metal microparticles in the active material layer increases toward the current collector from a surface of the active material layer.

9. The method for manufacturing a battery electrode according to claim 6, wherein forming the active material layer includes forming a conductive section having a protruded shape by applying the liquid body including the metal material on the surface of the current collector.
